(19) United States
(12) Patent Application Publication
(10) Pub. No.: US 2020/0198106 A1
(43) Pub. Date: Jun. 25, 2020

(54) WRENCH AND WRENCH ASSEMBLY CAPABLE OF BEING ROTATED QUICKLY

(71) Applicant: Chih-Min CHANG, XIUSHUI TOWNSHIP (TW)

(72) Inventor: Chih-Min CHANG, XIUSHUI TOWNSHIP (TW)

(21) Appl. No.: 16/364,759

(22) Filed: Mar. 26, 2019

(30) Foreign Application Priority Data
Dec. 19, 2018 (TW) 107217248

(51) Int. Cl. B25B 23/16; B25B 13/46

(52) U.S. Cl. CPC B25B 23/16; B25B 13/46

(57) ABSTRACT

A wrench assembly capable of being rotated quickly is adapted for rotating a fastener. The wrench assembly includes a wrench and an inserting member. The wrench includes an acting head and a handle. The acting head is adapted to be combined with the fastener. The handle is connected with the acting head and extends along a horizontal direction. The handle is provided at an end thereof far away from the acting head with an inserted hole portion. The inserting member is detachably inserted in the inserted hole portion along a vertical direction.

### BACKGROUND OF THE INVENTION

### 1. Field of the Invention

The present invention relates to the wrench defined in International Patent Classification NO. B25B013.

### 2. Description of the Related Art

The wrench is a hand tool for rotating a fastener such as a bolt, a nut, and so on. In order to provide a long arm of force for rotation, the handle of the wrench usually has a quite length, so that the user can hold the tail end of the handle to rotate the wrench and tighten the fastener.

However, ergonomically, the lower arm can be bent inwardly relative to the body, but can't be bent outwardly. When the user holds the wrench to rotate the fastener, the arm of the user can only rotate inwardly toward the body for a certain angle, and then the user has to remove the wrench from the fastener and re-sleeve the wrench onto the fastener to rotate the fastener once more. It can be known from such process that the operation of the traditional wrench is time-consuming and inefficient.

### SUMMARY OF THE INVENTION

It is one of the objectives of the present invention to provide a wrench which can be rotated quickly.

According to the embodiments in the following description, a wrench assembly capable of being rotated quickly is adapted for rotating a fastener. The wrench assembly includes a wrench and an inserting member. The wrench includes an acting head and a handle. The acting head is adapted to be combined with the fastener. The handle is connected with the acting head and extends along a horizontal direction. The handle is provided at an end thereof far away from the acting head with an inserted hole portion. Besides, the inserting member is detachably inserted in the inserted hole portion along a vertical direction. Through the afore-described configuration design of the wrench assembly, the user can hold the inserting member at various angles, so as to easily rotate the wrench assembly to tighten the fastener quickly.

In one aspect, the wrench may be, for example, an open-end wrench, a box-end wrench or a ratchet wrench, therefore the structure of the acting head may be correspondingly configured as a C-shaped structure or a socket structure for being combined with a screw or a nut.

In another aspect, the cross section of the inserted hole portion may be shaped as a circle or a polygon. For example, the inserted hole portion has a polygonal hole which may extend along the vertical direction and communicate with the exterior of the wrench. In the case that the cross section of the inserted hole portion is polygon-shaped, when the user holds the inserting member to rotate the wrench, the inserting member can be inserted in the inserted hole portion of the handle firmly. Besides, in the process that the user rotates the wrench, the inserting member will not spin relative to the handle, convenient for the user to rotate the wrench quickly.

In another aspect, for attaining quick-release effect, the inserted hole portion has an inner wall which is provided with a concave part. Besides, the inserting member includes an inserting head which has an accommodating trough, a ball and an elastic member. The inserting head has an opening communicating with the accommodating trough. The ball and the elastic member are disposed in the accommodating trough. Two ends of the elastic member are abutted against the bottom of the accommodating trough and the ball respectively in a way that the ball can be pushed by the elastic member to partially protrude out of the opening and correspond to the concave part. When the user inserts the inserting member into the inserted hole portion, the ball can be engaged with the concave part.

In another aspect, the inserted hole portion penetrates through the top surface and the bottom surface of the handle, so that the user can insert the inserting member from the top surface or the bottom surface.

### BRIEF DESCRIPTION OF THE DRAWINGS

The detailed structure, features, assembly or usage manner related to the wrench assembly will be described in the embodiments given herein below. However, it should be understood that the embodiments to be described below and the accompanying drawings are given for illustration only, not limitation on the claimed scope of the present invention, and wherein:

FIG. 1 is a perspective view of a wrench assembly of an illustrative first embodiment;

FIG. 2 is a partial sectional view of a wrench of the illustrative first embodiment;

FIG. 3 is a partial sectional view of an inserting member of the wrench assembly of the illustrative first embodiment;

FIGS. 4 and 5 are schematic views showing the operation of the wrench assembly of the illustrative first embodiment;

FIG. 6 is a perspective view of a wrench assembly of an illustrative second embodiment;

FIG. 7 is a perspective view of a wrench of an illustrative third embodiment.

### DETAILED DESCRIPTION OF THE INVENTION

The technical content and features of the present invention will be specified in the following description of the illustrative embodiments and the accompanying drawings. The directional phraseology mentioned in the content of the following embodiments, such as the words “on”, “under”, “in”, “out”, “top” and “bottom”, are only used for the illustrative description based on the normal usage direction, not intended to limit the claimed scope.

For the detailed description of the technical features of the present invention, three illustrative embodiments and the accompanying drawings are given herein below.

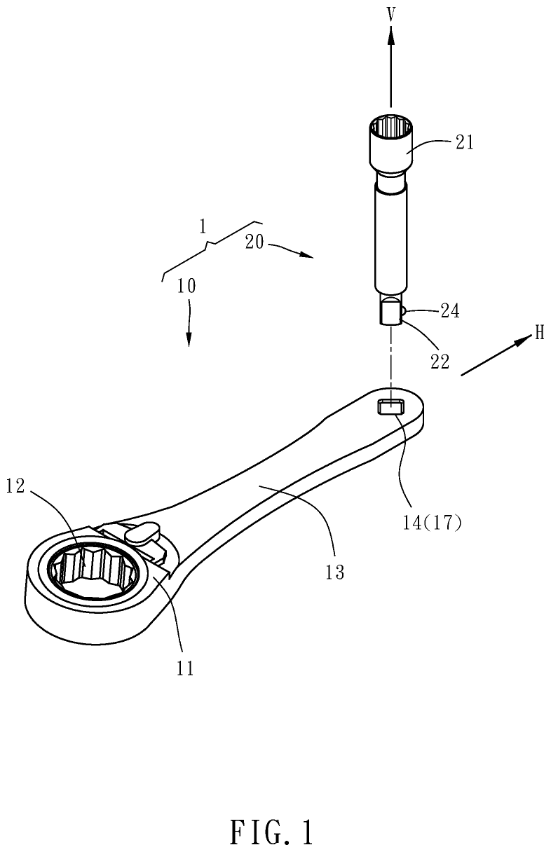

As shown in FIG. 1, the wrench assembly 1 of the first embodiment includes a wrench 10 and an inserting member 20.

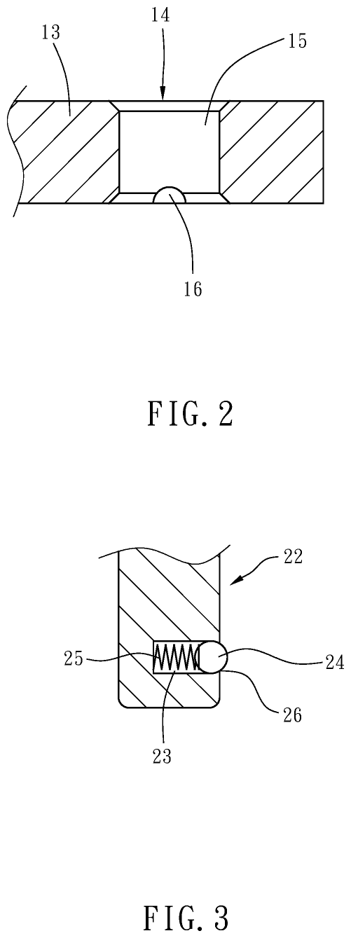

The wrench 10 includes an acting head 11 and a handle 13. The acting head 11 is adapted to be combined with a fastener which may be a head of a screw or a nut. In this embodiment, the wrench 10 is a ratchet wrench and is used to rotate a screw. The acting head 11 is configured as a socket structure, thereby having a polygonal hole 12. The socket structure is provided therein with a ratchet (not shown). The polygonal hole 12 is adapted to be sleeved onto the head of the screw. The handle 13 is connected with the acting head 11 and extends along a horizontal direction H. The handle 13 is provided at an end thereof far away from the acting head 11 with an inserted hole portion 14. The inserted hole portion 14 also has a polygonal hole 17. The cross section of the inserted hole portion 14 is shaped as a square. The inserted hole portion 14 is hollow-shaped. The inserted hole portion 14 (the polygonal hole 17) extends along a vertical direction V and penetrates through the top surface and the bottom surface of the handle 13 to communicate with the exterior of the wrench 10. As shown in FIG. 2, the inserted hole portion 14 has an inner wall 15 which is provided with a concave part 16. The concave part 16 is located at the bottom side of the handle.

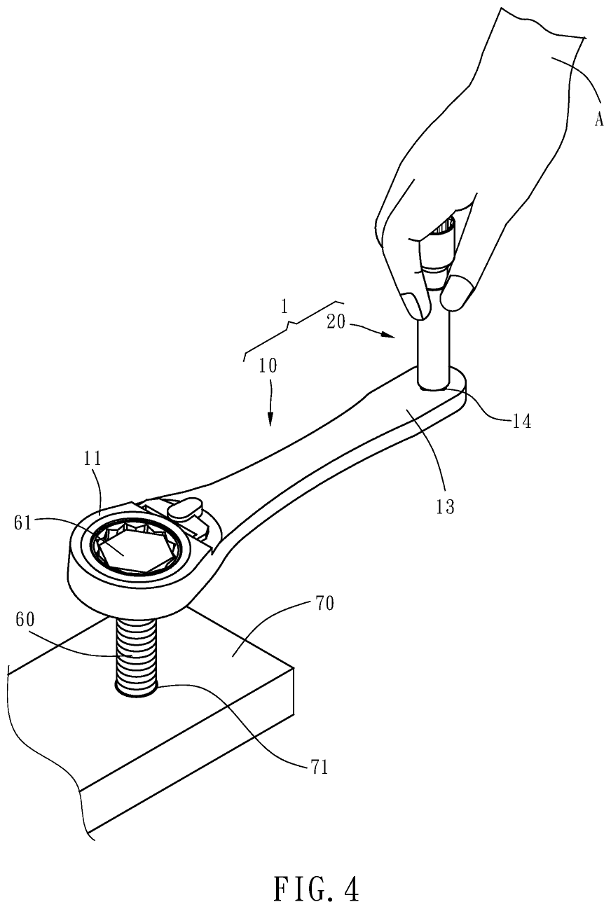

Referring to FIG. 1, the inserting member 20 is provided at two opposite ends thereof with a socket 21 and an inserting head 22 respectively. The inserting head 22 is shaped as an elongated rod and the cross section thereof is square-shaped. The size of the inserting head 22 corresponds to the size of the inserted hole portion 14 in a way that the inserting member 20 can be detachably inserted into the inserted hole portion 14 along the vertical direction V. Referring to FIG. 3, the inserting head 22 has an accommodating trough 23, a ball 24 and an elastic member 25 which is a compression spring in this embodiment. The inserting head 22 has an opening 26 communicating with the accommodating trough 23. The ball 24 and the elastic member 25 are disposed in the accommodating trough 23. Two opposite ends of the elastic member 25 are abutted against the bottom of the accommodating trough 23 and the ball 24 respectively in a way that the ball 24 can be pushed by the elastic member 25 to partially protrude out of the opening 26. It should be explained that a machine may be used to process the opening 26 by pressing to cause the opening 26 a little deformed toward the inside of the accommodating trough 23, thereby limiting the ball 24 from dropping out of the accommodating trough 23. Besides, the ball 24 is located correspondingly to the concave part 16 of the inserted hole portion 14. Therefore, when the inserting member 20 is inserted in the inserted hole portion 14, the ball 24 can be abutted outwardly and engaged with the concave part 16, causing the wrench 10 combined with the inserting member 20 firmly.

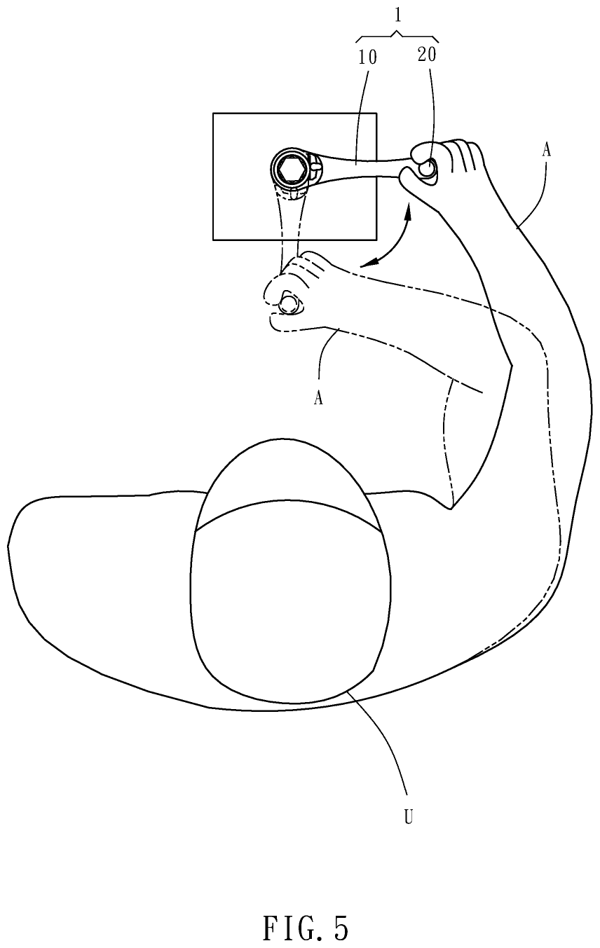

In use, refer to FIGS. 4 and 5. When a user U wants to use the wrench assembly 1 of this embodiment to tightly screw a screw 60 into a threaded hole 71 of a plate 70, the user U firstly sleeves the acting head 11 onto a head 61 of the screw 60, and then inserts the inserting member 20 into the inserted hole portion 14 of the wrench 10 to combine the inserting member 20 and the wrench 10 together. After that, the user U can hold the inserting member 20 in the manner as shown in FIG. 4 or in an encircling holding manner. Because of the various holding angles, the user U is no longer limited to hold the handle 13 to rotate the wrench 10 toward the body. In comparison, by using the wrench assembly 1 of this embodiment, the user U can keep the bottom arm A bent inwardly and holding the inserting member 20 to make it circuit so as to rotate the wrench 10 quickly, as shown in FIG. 5. At last, when the screw 60 is almost tightened but needs the user U to apply the wrench 10 a relatively larger force, the user U can detach the inserting member 20 and then hold the handle 13 of the wrench 10 to tighten the screw 60.

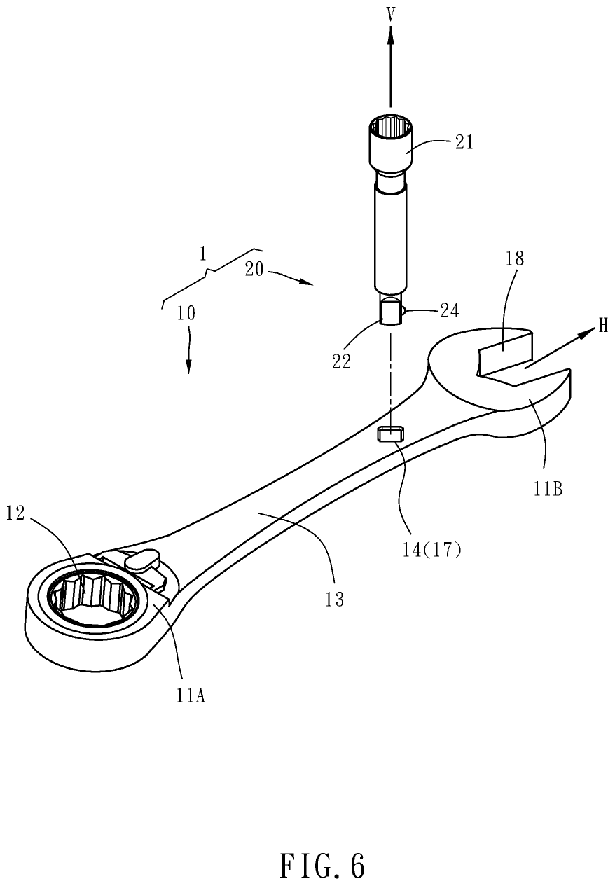

Referring to FIG. 6, the main structure of the wrench assembly 1 of the second embodiment is approximately the same with the first embodiment, but one of the differences therebetween is that in the second embodiment the wrench 10 includes two acting heads 11A and 11B and a handle 13. The aforesaid two acting heads 11A and 11B are located at two opposite sides of the handle 13 respectively. The acting head 11A is configured as a socket structure which is provided therein with a ratchet, so that the wrench 10 can serve as a ratchet wrench through the acting head 11A. On the other hand, the acting head 11B is configured as an embedding structure which has an open hexagonal hole 18, so that the wrench 10 can serve as an open wrench through the acting head 11B. In the second embodiment, the inserted hole portion 14 is provided on the handle 13 and located relatively farther away from the acting head 11A and relatively closer to the acting head 11B, so that the user U can hold the inserting member 20 to rotate the acting head 11A quickly.

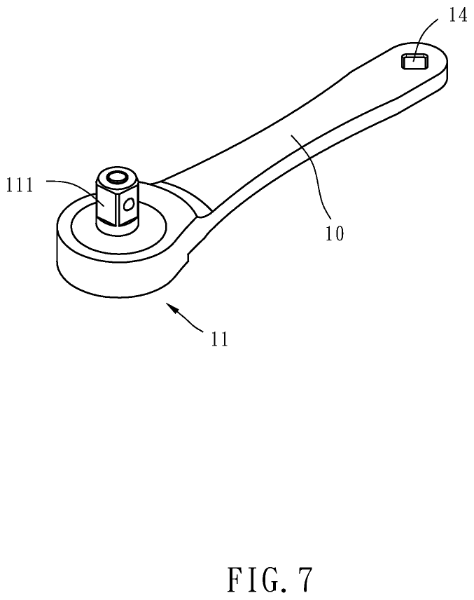

Referring to FIG. 7, the main structure of the wrench assembly 1 of the third embodiment is approximately the same with the first embodiment, but one of the differences therebetween is that in the third embodiment the acting head 11 of the wrench 10 includes a socket connecting head 111 and a ratchet trough hidden under the socket connecting head 111 and thereby not shown in the figure. The socket connecting head 111 is provided at the bottom thereof with ratchet teeth (not shown), which can cooperate with the ratchet trough so that the wrench 10 can only rotate in one direction. The socket connecting head 111 is adapted for sockets with various sizes to be sleeved thereonto. In the third embodiment, the handle 13 of the wrench 10 is also provided with the inserted hole portion 14 which is located relatively farther away from the acting head 11, so that the user U can hold the inserting member 20 to rotate the acting head 11 quickly.

The illustrative embodiments described above are given for specifying the practical embodied types of the preferred embodiments of the present invention. The present invention is unlimited to the above-described illustrative embodied types, and the modifications and variations made thereto and not to be regarded as a departure from the spirit and scope of the invention are intended to be included within the scope of the present invention.

What is claimed is:

1. A wrench assembly capable of being rotated quickly, which is adapted for rotating a fastener, the wrench assembly comprising:
a wrench comprising an acting head and a handle, the acting head being adapted to be combined with the fastener, the handle being connected with the acting head and extending along a horizontal direction, the handle being provided at an end thereof far away from the acting head with an inserted hole portion;
an inserting member detachably inserted in the inserted hole portion along a vertical direction.

2. The wrench assembly as claimed in claim 1, wherein a cross section of the inserted hole portion is shaped as a polygon.

3. The wrench assembly as claimed in claim 2, wherein the inserted hole portion has an inner wall which is provided with a concave part.

4. The wrench assembly as claimed in claim 3, wherein the inserting member comprises an inserting head which has an accommodating trough, a ball and an elastic member; the inserting head has an opening communicating with the accommodating trough; the ball and the elastic member are disposed in the accommodating trough; two ends of the elastic member are abutted against a bottom of the accommodating trough and the ball respectively in a way that the ball is capable of being pushed by the elastic member to partially protrude out of the opening and the ball is located correspondingly to the concave part.

5. The wrench assembly as claimed in claim 2, wherein the inserted hole portion penetrates through a top surface and a bottom surface of the handle.

6. The wrench assembly as claimed in claim 1, wherein the inserted hole portion has an inner wall which is provided with a concave part.

7. The wrench assembly as claimed in claim 6, wherein the inserting member comprises an inserting head which has an accommodating trough, a ball and an elastic member; the inserting head has an opening communicating with the accommodating trough; the ball and the elastic member are disposed in the accommodating trough; two ends of the elastic member are abutted against a bottom of the accommodating trough and the ball respectively in a way that the ball is capable of being pushed by the elastic member to partially protrude out of the opening and the ball is located correspondingly to the concave part.

8. The wrench assembly as claimed in claim 1, wherein the inserted hole portion penetrates through a top surface and a bottom surface of the handle.

9. The wrench assembly as claimed in claim 1, wherein the wrench further comprises another acting head; the two acting heads are connected to two opposite sides of the handle respectively; the inserted hole portion is located relatively farther away from one of the two acting heads and relatively closer to the other of the two acting heads.

10. A wrench capable of being rotated quickly, which is adapted for rotating a fastener, the wrench comprising an acting head and a handle, the acting head being adapted to be combined with the fastener, the handle being connected with the acting head and extending along a horizontal direction, the wrench being characterized in that the handle is provided at an end thereof far away from the acting head with an inserted hole portion and the inserted hole portion has a polygonal hole extending along a vertical direction and communicating with an exterior of the wrench.

11. The wrench as claimed in claim 10, wherein the polygonal hole penetrates through a top surface and a bottom surface of the handle.

12. The wrench as claimed in claim 11, wherein the acting head is a socket structure.

13. The wrench as claimed in claim 10, wherein the wrench further comprises another acting head; the two acting heads are connected to two opposite sides of the handle respectively; the inserted hole portion is located relatively farther away from one of the two acting heads and relatively closer to the other of the two acting heads.
